(19) United States
(12) Patent Application Publication
(10) Pub. No.: US 2007/0178243 A1
(43) Pub. Date: Aug. 2, 2007

(54) Water-based faux finish and methods

(75) Inventors: Merle Houck, Liberty, MO (US); Gerald M. Russo, Downers Grove, IL (US)

Correspondence Address: MARSHALL, GERSTEIN & BORUN LLP, 233 S. WACKER DRIVE, SUITE 6300, SEARS TOWER, CHICAGO, IL, 60606, US

(73) Assignee: ROMAN DECORATING PRODUCTS, Calumet City, IL (US)

(21) Appl. No.: 11/343,172

(22) Filed: Jan. 30, 2006

(51) Int. Cl. B05D 7/00; B05C 1/00; B29B 15/10; B05D 1/28; B05D 1/02

(52) U.S. Cl. 427/428.01; 427/421.1; 427/402; 118/200

(57) ABSTRACT

Methods and compositions for applying a faux finish to a surface; as with a water-based base/primer to initially coat the surface with a base coat that is highly viscous and includes a relatively high percentage of solids that provide a three-dimensional coating having upwardly extending solids; the process may include applying a heavy coating of a second base coat, containing said solid particles, using a roller or sponge roller to provide raised areas (a multi-level surface); optionally applying one or more additional heavy base coats, in the same or different directions; optionally immediately flattening a portion of the surface of the base coat(s); rolling or spraying on a final coating of a glaze coat having a different color or tint than the base coat(s); and moving a portion of the glaze coat, preferably with a squeegee from higher areas to lower areas to visibly uncover a portion of the base coat, or to reveal a different shade of the base coat, due to a thinner glaze coat in higher areas where the glaze coat was moved, in a regular pattern.

Described herein are water-based faux finish coating compositions and alternative methods of providing faux finishes on planar surfaces, particularly interior wall and ceiling surfaces of homes, businesses, hotels, and the like. More particularly, the coating compositions and methods described herein are designed for use by the typical homeowner, painting contractor or unskilled painter, who has little or no experience in applying faux finishes the compositions and methods described herein are easy to apply and provide a consistent faux finish over large surface areas by the homeowner or commercial painter unskilled in the art of traditional faux finish.

### BACKGROUND

The art of creating faux finishes has been practiced for centuries. There have been essentially two methods known for the production of faux finishes, namely, the positive and negative methods. These methods are described in Isabel O'Neil, The Art of the Painted Finish for Furniture & Decorations (1971). The term “positive” describes those processes in which the pattern is created by flooding the surface with a base color and applying other colors, in a pattern, to the wet base-colored surface. Another positive method includes laying floating colors on a dry surface and inducing them to flow with a spattering of mineral spirits.

U.S. Pat. No. 4,508,736 discloses a positive method for producing a pattern upon a cylindrical body such as a pen. The method includes spraying a first coat of lacquer onto the object, curing this coat, and then rolling the object along a textured patterning pad which applies a second coat. A hard, resinous, protective coating may be applied over the dried second coat.

The negative method involves the creation of a pattern by the partial removal of a top coat of paint. The methods described herein rely upon the movement of a glaze or top coat of paint from high to low areas of a three-dimensional base coat.

### SUMMARY

Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

The methods described herein are neutral methods that initially coat, via roller or spray, with a water-based base/primer to initially coat the surface with a base coat that is highly viscous and includes a relatively high percentage of solids that provide a three-dimensional coating having upwardly extending solids; the process may include applying a heavy coating of a second base coat, containing said solid particles, using a roller or sponge roller to provide raised areas (a multilevel surface); optionally applying one or more additional heavy base coats, in the same or different directions; optionally immediately flattening a portion of the surface of the base coat(s); rolling or spraying on a final coating of a glaze coat having a different color or tint than the base coat(s); and moving a portion of the glaze coat, preferably with a squeegee from higher areas to lower areas to visibly uncover a portion of the base coat, or to reveal a different shade of the base coat, due to a thinner glaze coat in higher areas where the glaze coat was moved, in a regular pattern.

Known compositions and methods for applying a faux finish to a wall generally requires some degree of artistic talent and multiple days in order to provide a consistent visual appearance to a wall surface.

In accordance with the preferred embodiment, the base coat can be applied, partially or fully dried and the final or glaze coating applied and worked in 8 hours or less. To achieve the full advantage of the coating compositions and methods described herein, the coating compositions are completely water-based, having no hydrocarbon solvents and the installation processes described herein allow large areas to be decorated quickly with a consistent appearing finish requiring essentially no artistic talent.

The coating compositions and methods described herein provide a multi-level or raised surface base coat that is partially or fully dried prior to applying a glaze coat which is moved from higher areas of the base coat to lower areas of the base coat in order to provide a variety of surface finishes that are easily and consistently applied over large surface areas by the homeowner or commercial painter unskilled in the art of traditional faux finish.

### DETAILED DESCRIPTION OF THE PREFERRED EMBODIMENTS

The base coat compositions described herein include a resin polymer and/or resin copolymer, preferably an acrylic polymer or acrylic copolymer, as an emulsified water latex in an amount of at least about 20% by weight (active acrylic), preferably about 25% to about 40% by weight, more preferably about 30-40% by weight, based on the total weight of the wet base coating composition. A humectant, such as propylene glycol and/or ethylene glycol, preferably propylene glycol, optionally is included in the base coating compositions in an amount of 0% by weight up to about 5% by weight, preferably about 1% to about 2% by weight, based on the total weight of the wet base coating composition. Water is included in the base coating composition in an amount of about 10% to about 50% by weight of the wet composition, preferably about 30% to about 40% by weight. One or more thickeners, such as clay thickeners, cellulose thickeners, and/or polymer thickeners are included in the base coating compositions in an amount sufficient to provide the base coat composition with a viscosity of at least about 30,000 cps, as measured by a Brookfield viscometer using spindle # 7 at 20 rpm, preferably about 40,000-70,000 cps, more preferably about 50,000 cps. One or more organic or inorganic pigments and/or colorant compounds may be included in the base coating composition, such as lamp black; yellow iron oxide; red iron oxide; titanium dioxide; brown oxide; raw umber; burnt umber; phthalo blue; phthalo green; organic reds and organic yellows. A titanium dioxide pigment is preferred in order to provide a white base coat composition that is easily colored or tinted a desired color. Any dye or tint may be added to the base coating composition containing TiO₂ to provide any coloration to the base coat. One or more dispersants and/or surfactants are included in the base coating composition in an amount sufficient to maintain a homogenous emulsion, e.g. 0.01% about 1.0% by weight. One or more bactericides and fungicides are to ensure shelf life and provide dry film protection after installation.

In order to provide the faux finishes described herein, the base coating composition includes one or more fillers having a particle size in the range of about 5 μm to about 100 μm. The filler(s) provide the dried coating composition with a textured surface having raised areas for consistent, later partial movement of the glaze coating from higher to lower areas of the base coat. In the preferred embodiment, the filler is included in an amount of about 5% to about 55% by weight of the wet base coating composition, preferably about 30% to about 45% by weight. It has been found that excellent base coat textured surfaces are provided by a combination of a majority of a calcium carbonate filler, e.g., about 30% to about 50% by weight calcium carbonate, and 1% to about 10%, preferably about 2% to about 5% by weight feldspar filler, based on the total weight of the wet base coating composition. The preferred particle size for the calcium carbonate filler is about 5 μm to about 100 μm, more preferably about 10 μm to about 20 μm. The preferred particle size for the feldspar filler is about 5 μm to about 30 μm, more preferably about 10 μm to about 15 μm.

An example of the base and glaze coating compositions is included below together with percentage ranges and preferred ranges for the components contained in the base coating composition and subsequently applied glaze coating composition suitable for the faux finish methods described herein.

| | | Base Coat | | Glaze | |
|---|---|---|---|---|---|
| Ingredient | Purpose | Pounds | % Range | Pounds | % Range |
| water | solvent | 17.7 | 15-50 | 40.87 | 35-50 |
| prop glycol | humectant | 1.3 | 0-5 | 1 | 0-20 |
| Foamaster SA-3 | defoamer | 0.3 | 0.3-0.5 | 0.2 | 0.2-0.5 |
| Tego KL-245* | surfactant | 0.06 | 0.01-0.5 | 0.05 | 0.01-0.5 |
| Tego Dispers 651** | dispersant | 0.1 | 0.05-0.5 | 0.08 | 0.05-0.5 |
| nepheline syenite | feldspar filler | 3.6 | 0-5 | 25 | 20-40 |
| (Minex 4) | | | | | |
| clay (ATTAGEL 50)*** | thickener | 0.8 | 0-1 | 0 | 0 |
| titanium dioxide | white pigment | 4.1 | 1-20 | 0.6 | 0-5 |
| (Huntsman R-XL) | | | | | |
| calcium carbonate | filler | 38.4 | 5-50 | 5.9 | 0-15 |
| (12 micron) | | | | | |
| cellulose thickener | filler | 0.4 | 0-0.5 | 0.3 | 0-0.5 |
| Natrosol 250 HBR3 | | | | | |
| BASF ACRONAL | acrylic polymer | 30.5 | 25-50 | 24 | 20-35 |
| 120 | emulsion | | | | |
| | 50% acrylic in water | | | | |
| TEXANOL**** | coalescent solvent | 2 | 0.5-2 | 1.5 | 0.5-2 |
| Troy K12N | bactericide | 0.24 | 0.2-0.3 | 0.2 | 0.2-0.3 |
| Rohm&Haas TT-935 | thickener | 0.5 | 0.25-1.0 | 0.5 | 0.25-1.0 |

| | | |
|---|---|---|
| Viscosity approx | 50,000 cps | 15,000 cps |
| Solids approx | 65% | 45% |

*polyether siloxane copolymer
**polyether (30% active in water)
***attapulgite day thickener
****2,2,4-trimethyl-1,3-pentane diol monoisobutyrate

The size of the acrylic particles in the acrylic latex emulsion preferably should be in the range of about 0.05 μm to about 0.3 μm, preferably about 0.2 μm to about 0.3 μm since the three-dimensional (revised) nature of the base coat is contributed essentially only by the filler(s).

Suitable water insoluble acrylic polymers and copolymers are the cross-linked polymers of acrylic or methacrylic acid derivatives, for example, acrylic acid, the alkali metal and ammonium salts of acrylic acid, methacrylic acid, the alkali metal and ammonium salts of methacrylic acid, acrylamide, methacrylamide, the N-alkyl substituted amides, the N-aminoalkylamides, and the corresponding N-alkylaminoalkyl substituted amides of acrylic acid and/or methacrylic acid; the aminoalkyl acrylates, the aminoalkyl methacrylamides and the N-alkyl substituted aminoalkyl esters of either acrylic or methacrylic acids, alkyl acrylates, alkyl methacrylates, and copolymers with acrylic acid, methacrylic acid, acrylamide, and/or methacrylamide. Additional suitable copolymers include vinyl acetate-ethylene (VAE) and ethylene-vinyl chloride (EVCL). These polymers may be the homopolymers or they may be copolymers with other copolymerizing monomers such as ethylene, propylene, isobutylene, styrene, α-methylstyrene, vinyl acetate, vinyl formate, alkyl ethers, acrylonitrile, methacrylonitrile, vinyl chloride, vinylidene chloride, the alkyl acrylates, the alkyl methacrylates, the alkyl maleates, and the alkyl fumarates, and other olefmic monomers copolymerizable therewith. The copolymers of this type, having at least 50 mole percent of the acrylic or methacrylic acid derivatives, are preferred. Polymers of this type may be prepared directly by the polymerization of suitable monomers, or by the after chemical reaction of other polymers, for example, by the hydrolysis of acrylonitrile or methacrylonitrile polymers.

Other suitable acrylic polymers and copolymers are polymerized from one or more of the following acrylic monomers: methyl acrylate, ethyl acrylate, propyl acrylate, isopropyl acrylate, n-butyl acrylate, sec-butyl acrylate, isobutyl acrylate, tert-butyl acrylate, hexyl acrylate, heptyl acrylate, 2-heptyl acrylate, 2-ethylhexyl acrylate, 2-ethylbutyl acrylate, dodecyl acrylate, hexadecyl acrylate, 2-ethoxyethyl acrylate, isobornyl acrylate, and/or cyclohexyl acrylate.

Suitable commercially available examples are sold as emulsified 50% acrylic solids in water, such as BASF ACRONAL Optive 120, or BASF ACRONAL Optive 230 Architectural coatings all-acrylic latex polymer. ACRONAL Optive 120 is preferred.

The latex coating composition components can be mixed together in any manner that produces a homogeneous emulsion. The preferred method of manufacturing the latex composition is to form an emulsified mixture of water; one or more humectants, e.g., propylene glycol; a portion of the thickener, such as a clay thickener, filler; pigment; and optionally a dispersant. Another portion of a thickener, preferably a cellulose thickener, then is added to the emulsion to increase the viscosity of the composition to a doughy consistency to aid in dispersing the pigments and fillers. The acrylic polymer latex emulsion then is added to thin the mixture. The latex emulsion is purchased as an emulsion containing about 50% by weight acrylic polymer solids. Additional thickener then is added to achieve a viscosity in the final composition in the range of about 40,000 cps to about 70,000 cps, as measured by a Brookfield viscometer, spindle #7 at 20 rpm. A bactericide and a fungicide can be added at any stage of the mixing process, preferably last. If necessary a coalescent solvent should be added together with the acrylic polymer, if needed for film forming.

In accordance with one important embodiment of the faux finish compositions and methods described herein, the base coating composition and the glaze coating composition are compatible and blendable latex (water-based) emulsions wherein neither the base coating composition nor the glaze coating composition includes an organic solvent. In the preferred embodiment, both the base and glaze coating compositions are colored white and both can be pre-tinted at the factory, or can be easily and quickly tinted with a tint of choice by the consumer at the point of purchase.

The faux finish methods described herein rely upon a high viscosity, higher solids-content base coating composition that can be sprayed, rolled or troweled onto walls. Simple tools such as putty knives, squeegees, wide brushes and the like, can be used to texturize the base coat before it dries. The base coat can be tinted with universal colorants commonly used in paints.

When the base coating composition has firmed, e.g., medium viscosity, or completely dried, a glaze coating is added by rolling, brushing or spraying. The glaze coating does not sag or drip readily due to its viscosity and is easily manipulated with tools such as a squeegee for shading effects. The glaze is essentially not removed (although a small amount, e.g., 5-10%, may be removed) but moved around on a 3dimensional base coat to form thick and thin glaze-coated areas, depending on the height of the extending solids in the base coat texture underneath. The glaze coating composition can be tinted with universal colorants commonly used in paints.

The base and glaze coating compositions can be used to produce large areas of faux finish in one day. Prior art oil-based faux finish compositions and methods require up to several days.

Other faux finish systems on the market use a smooth paint base coat, and a glaze that has to be mixed with paint or reactants before use. The compositions and methods described herein are designed to be used two ways: 1) right out of the can for do-it-yourselfers, wherein the base and glaze coating compositions are pre-tinted at the factory, and 2) a commercial version where tints can be added at the retail outlet if more custom looks are desired. Mixing of anything other than a colorant into the base and/or glaze coating compositions is not needed or advised for either version.

By using spray, roller or trowel application for applying the base coating composition, and spray or roller to apply the glaze, plus simple tools such as a squeegee for manipulating the glaze coating composition, a commercial painter or do-it-yourselfer can produce any size wall area of faux finish and have it look consistent from beginning to end. Common tools are used in a manner which does not require previous practice in order to produce a consistent finish. Other faux finish compositions and methods require considerable experience in order to make a consistent end-product. Rag-dragging and sponge dabbing techniques are very difficult to control in making a consistent finish.

The preferred faux finishes achievable with the base and glaze coating compositions described above include Tuscan, Fresco, Travertine and Striae finishes, wherein the base coating and glaze coating compositions are each tinted a different color or a different shade of the same color. The process steps are as follows:

Tuscan:

Step 1: roll or spray on base coat; Step 2A: apply a heavy base coat with a sponge roller in random directions, or, Step 2B: trowel on a second base coat in random directions; Step 3: immediately partially flatten raised areas with a taping knife in random directions. Wait 2 hours before applying glaze; Step 4:roll or spray on glaze coat over dried base coat; and Step 5: immediately move the glaze from higher to lower areas, using a squeegee, coat in random directions.
   Fresco:
Step 1: roll or spray on base coat; Step 2: apply heavy second base coat. Wait 1 minute, and. random back roll in an X pattern. Wait 2 hours before applying glaze; Step 3: roll or spray on glaze coat; Step 4: immediately move the glaze coat from higher to lower areas, using a squeegee, in random directions.
   Travertine:
Step 1: roll or spray on base coat; Step 2: apply heavy second base coat. Wait 1 minute, back roll from ceiling to floor; Step 3: wait 5 minutes and knockdown. Wait 2 hours before applying glaze; Step 4: roll or spray on glaze coat over dried base coat; Step 5: immediately move the glaze coat from higher to lower areas, using a squeegee, in random directions.
   Striae:
Step 1: roll or spray on base coat; Step 2: heavy roll or spray on second base coat. Immediately pull through with a wallpaper brush starting at the ceiling. Wait 2 hours before applying glaze; Step 3: roll or spray on glaze over dried base coat; Step 4: roll or spray on glaze over dried base coat; Step 5: immediately move the glaze coat from higher to lower areas, using a squeegee, starting at ceiling.

Damage to a wall finish that has been faux finished in accordance with the compositions and methods described herein is easily repaired by following the same steps only on the damaged area and the repaired and newly finished wall portion blends invisibly with the previously finished, undamaged wall portion. Traditional faux finishes are difficult to repair and large areas usually need to be extensively redone to be aesthetically acceptable to the property owner.

1. A kit for applying a faux finish on a surface comprising a base coating composition having a viscosity of at least 30,000 cp, as measured by a Brookfield Viscometer at 20 rpm using spindle #7, and a glaze coating composition having a viscosity of at least 10,000 cps, as measured by a Brookfield Viscometer at 20 rpm using spindle #7, wherein the base coating composition has a higher solids content than the glaze coating composition, and the base and glaze coating compositions include the following components:

| Wet Base Coating | | Wet Glaze Coating |
|---|---|---|
| Composition Component | Wt. % | Component Wt. % |
| water | 10-50 | 35-50 |
| solid filler | 5-55 | 0-40 |
| surfactant | 0.01-0.5 | 0.01-0.5 |
| dispersant | 0.05-0.5 | 0.05-0.5 |
| water-emulsified polymer or copolymer | 12.5-25 | 20-35 |

2. The kit of claim 1 further including a paint roller, a paint tray, and a squeegee.

3. The kit of claim 1, wherein the solid filler has a particle size in the range of about 5 μm to about 100 μm.

4. The kit of claim 2, wherein the solid filler has a particle size in the range of about 10 μm to about 20 μm.

5. The kit of claim 2, wherein the thickener is selected from the group consisting of a cellulose thickener, a clay thickener, a polymeric thickener, and a combination thereof.

6. The kit of claim 1, wherein the base coating composition and the glaze coating composition are as follows:

| | Base Coat | Glaze Coat |
|---|---|---|
| Ingredient | % Range | % Range |
| water | 15-20 | 35-50 |
| humectant | 0-5 | 0-20 |
| surfactant | 0.01-0.5 | 0.01-0.5 |
| dispersant | 0.05-0.5 | 0.05-0.5 |
| feldspar filler | 0-5 | 10-40 |
| thickener | 0.25-2.0 | 0.25-1.0 |
| solid filler (5 μm-100 μm) | 5-50 | 0-15 |
| acrylic polymer emulsion | 12.5-25 | 20-35 |

7. The kit of claim 1, wherein the base coating composition and glaze coating composition each include TiO₂ pigment and each composition is colored white.

8. The kit of claim 7, wherein the base coating composition includes a colorant to color the base coating composition a first color, different from white, and the glaze coating composition includes a different colorant than the base coating composition, or a different percentage of the same colorant such that the colors of the base coating composition and the glaze coating composition are visually distinguishable.

9. The kit of claim 1, wherein the base coating composition includes a colorant to color the base coating composition a first color and the glaze coating composition includes a different colorant than the base coating composition, or a different percentage of the same colorant, such that the colors of the base coating composition and the glaze coating composition are visually distinguishable.

10. A method of applying a decorative, faux finish onto a surface comprising:
(a) applying, via paint roller and/or spray, a base coat of an emulsified polymer-containing water-based base coating composition having 5 to 50% by weight of a solid filler having a particle size in the range of about 5 μm to about 100 μm; said base coating composition having a viscosity of at least 30,000 cps as measured on a Brookfield Viscometer at 20 rpm using spindle #7 and optionally applying, via paint roller, one or more additional layers of said base coating composition over said base coat;
(b) rolling or spraying on a final coating of a glaze coat from a glaze coating composition, having a different color or tint than the base coat(s), said glaze coating composition having a smaller percentage of solid filler than said base coating composition and having a viscosity of at least 10,000 cps, as measured on a Brookfield Viscometer at 20 rpm using spindle #7; and
(c) moving a portion of the glaze coating composition from higher areas of said base coat to lower areas of said base coat to visibly uncover a portion of the base coat, or to reveal a different shade of the base coat, due to a thinner glaze coating in higher areas where the glaze coat was moved.

11. A method in accordance with claim 10, further including the step of partially flattening upstanding solid particles in said base coat prior to applying the glaze coat.

12. A method in accordance with claim 10, further including applying multiple layers of said base coating composition prior to said final glaze coat.

13. A method in accordance with claim 12, wherein at least a portion of the base coating composition is applied using a paint roller that is rolled in different directions onto the surface.

14. A method in accordance with claim 10, wherein the glaze coating composition is moved from higher areas to lower areas of the base coat using a squeegee.

15. A method in accordance with claim 14, wherein the surface coated is a wall, and the glaze coating composition is moved from higher to lower areas of the base coat by scraping the glaze coating composition with a squeegee from an upper wall portion to a lower wall portion.

16. A method in accordance with claim 10, wherein the base coating composition and the glaze coating composition comprise the following:

| Wet Base Coating | | Wet Glaze |
|---|---|---|
| Composition Component | Wt. % | Coating Component Wt. % |
| water | 10-50 | 35-50 |
| solid filler | 5-55 | 0-40 |
| surfactant | 0.01-0.5 | 0.01-0.5 |
| dispersant | 0.05-0.5 | 0.05-0.5 |
| acrylic polymer or copolymer | 12.5-25 | 20-35 |

17. A method in accordance with claim 16, wherein the solid filler has a particle size in the range of about 5 μm to about 100 μm.

18. A method in accordance with claim 17, wherein the solid filler has a particle size in the range of about 10 μm to about 20 μm.

19. A method in accordance with claim 16, wherein the thickener is selected from the group consisting of a cellulose thickener, a clay thickener, a polymeric thickener, and a combination thereof.

20. A method in accordance with claim 16, wherein the base coating composition and glaze coating composition each include TiO₂ pigment and each composition is colored white.

21. A method in accordance with claim 20, wherein the base coating composition includes a colorant to color the base coating composition a first color, different from white, and the glaze coating composition includes a different colorant than the base coating composition, or a different percentage of the same colorant such that the colors of the base coating composition and the glaze coating composition are visually distinguishable.

22. A method in accordance with claim 16, wherein the base coating composition includes a colorant to color the base coating composition a first color and the glaze coating composition includes a different colorant than the base coating composition, or a different percentage of the same colorant, such that the colors of the base coating composition and the glaze coating composition are visually distinguishable.

23. A method as defined in claim 16, wherein the base coating composition and the glaze coating composition comprise the following:

| | Base Coat | Glaze Coat |
|---|---|---|
| Ingredient | % Range | % Range |
| water | 15-20 | 35-50 |
| humectant | 0-5 | 0-20 |
| surfactant | 0.01-0.5 | 0.01-0.5 |
| dispersant | 0.05-0.5 | 0.05-0.5 |
| feldspar filler | 0-5 | 10-40 |
| thickener | 0.25-2.0 | 0.25-1.0 |
| solid filler (5 μm-100 μm) | 5-50 | 0-15 |
| acrylic polymer emulsion | 12.5-25 | 20-35 |
